(19) United States
(12) Patent Application Publication
(10) Pub. No.: US 2026/0365092 A1
(43) Pub. Date: Nov. 19, 2026

(54) CUSHION ASSEMBLY

(71) Applicant: LEAR CORPORATION, Southfield, MI (US)

(72) Inventors: Curtis HUDSON, Macomb, MI (US); Mark KARGES, Macomb, MI (US); Joshua HALLOCK, Warren, MI (US)

(73) Assignee: LEAR CORPORATION, Southfield, MI (US)

(21) Appl. No.: 19/137,538

(22) PCT Filed: Oct. 13, 2023
(86) PCT No.: PCT/US2023/035071

§ 371 Date: Jun. 10, 2025

Related U.S. Application Data
(60) Provisional application No. 63/435,952, filed on Dec. 29, 2022.

(30) Foreign Application Priority Data
Aug. 21, 2023 (DK) PA202370425

(51) Int. Cl. B60N 2/58

(52) U.S. Cl. CPC B60N 2/5891

(57) ABSTRACT

A product is provided with a body formed from a plurality of strands of expanded thermoplastic resin with a nonrectangular cross section. A concentration of the plurality of strands about a perimeter of the nonrectangular cross section is greater than within the perimeter to provide a contact surface about the perimeter.

### CROSS-REFERENCE TO RELATED APPLICATIONS

This application claims priority to Denmark patent application Serial No. PA 2023 70425 filed Aug. 21, 2023, which in turn, claims priority to U.S. provisional patent application Ser. No. 63/435,952 filed Dec. 29, 2022.

### TECHNICAL FIELD

Various embodiments relate to cushion assemblies for seating assemblies.

### BRIEF DESCRIPTION OF THE DRAWINGS

FIG. 1 is a front perspective view of a seat assembly according to an embodiment;

FIG. 2 is a front partial perspective view of a cushioning pad of the seat assembly of FIG. 1, according to an embodiment;

FIG. 3 is a front elevation schematic view of a system to manufacture the seat cushioning pad of FIG. 2;

FIG. 4 is a front elevation view of a cushioning pad;

FIG. 5 is an enlarged front perspective view of a tooling plate of the system of FIG. 3; and

FIG. 6 is an enlarged front perspective view of the system of FIG. 3.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising.” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

FIG. 1 illustrates a seat assembly 20 as a vehicle seat assembly 20 according to an embodiment. Although the vehicle seat assembly 20 is illustrated and described, any seat assembly 20 may be employed. The seat assembly 20 may be utilized in a land vehicle, aircraft, watercraft, or the like. The seat assembly 20 may also be utilized as an office chair, comfort chair, or the like.

The depicted seat assembly 20 includes a seat bottom cushion 22 to support a pelvis and thighs of a seated occupant. The seat assembly 20 also includes a seat back cushion 24 to support a back and shoulders of the seated occupant. A trim cover 26 is provided over the seat cushions 22, 24 to conceal the cushions 22, 24 and provide a uniform and smooth contact surface for the occupant.

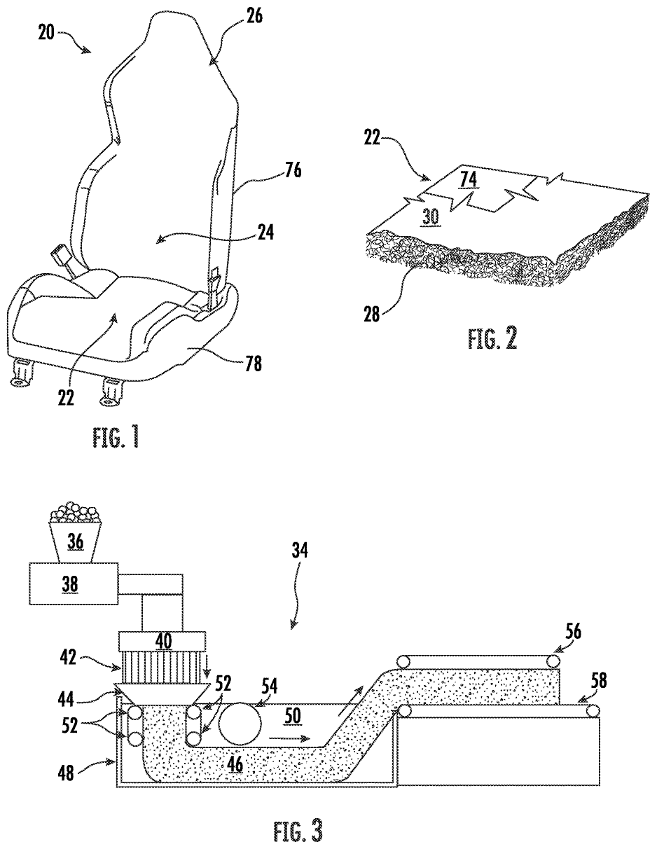

Referring now to FIG. 2, one of the seat cushions 22 is partially illustrated disassembled from the seat assembly 20. The seat cushion 22 is formed from a plurality of strands 28 of an extruded, expanded thermoplastic resin. The seat cushion 22 is also formed with a layer or film 30 of extruded thermoplastic resin strands 28 that are concentrated, bonded to, and formed unitarily with, the plurality of strands 28.

Referring now to FIG. 3, the seat cushions 22, 24 are manufactured from a system 34 and a process of extruded thermoplastic resin mesh. A hopper 36 holds material stock that is to be extruded, e.g., as solid granules or pellets of the material. The material may be provided by plastic, such as a linear low-density polyethylene (LLDPE). The material is fed from the hopper 36 to an extruder 38.

The extruder 38 melts and transports the material to a die plate 40. In one non-limiting example, the extruder 38 includes a barrel that receives a rotatable screw, as well as heating elements. Rotation of the screw forces the material to move through the barrel and helps heat the material due to the friction generated as the screw rotates. The material exits the extruder 38 under pressure and in a molten state.

The die plate 40 extrudes the material into filaments 42. The die plate 40 may be provided as described below depending on the direction of the extrusion relative to the final member 22, 24 produced from it. More specifically, the die plate 40 has multiple small circular, through holes or apertures through which the molten material passes. A single filament 42 is extruded from each die plate hole. The filaments 42 fall downward from the die plate under system pressure and the force of gravity to a funnel 44 as described below. The funnel 44 may have a cross-sectional shape that is the same as, or is different than, a shape collectively defined by the apertures in the die plate 40.

The funnel 44 helps consolidate or group the filaments 42 into a more compact arrangement in which the filaments 42 bend or loop and each filament 42 contacts and bonds to at least one other filament 42. The funnel 44 has a funnel inlet and a funnel outlet that is smaller than the funnel inlet. The funnel 44 is narrower at the funnel outlet than at the funnel inlet. Individual separated filaments 42 enter the funnel inlet, the filaments 42 bend/loop and move into contact as they accumulate and slide down the funnel 44 toward the funnel outlet, and the consolidated filament structure 46 exits the funnel outlet and immediately enters a water tank.

A liquid tank 48 holds water 50, coolant, or another fluid, and receives the consolidated filament structure 46 from the funnel 44. The liquid 50 in the bath 48 helps temporarily support the consolidated filament structure 46 to prevent the filament structure from collapsing or condensing into a less open or less porous arrangement and helps maintain the desired porosity and density. As such, the liquid 50 provides some resistance that causes additional bending and looping of the filaments 42 to further build the consolidated filament structure 46. Second, the liquid 50 cools the filaments 42 from the outside to solidify the filaments 42 and prevent the filaments 42 from bonding at additional locations.

The tank 48 includes various rollers and conveyors that help move the consolidated filament structure 46 through the liquid 50 and out of the liquid 50, such as a tractor conveyor 52. The rollers and conveyors speed may be controlled to move the consolidated filament structure 46 away from the funnel 44 at a speed that is dependent on the speed that the consolidated filament structure 46 exits the funnel 44.

Other rollers, such as roller 54 helps keep the consolidated filament structure 46 submerged in the liquid 50 and guides the consolidated filament structure 46 through the liquid 50 toward a conveyor belt 56 and shaker table 58 that are disposed outside of the tank 48. The shaker table 58 shakes the consolidated filament structure 46 while it is on the conveyor belt 56 to remove liquid 50. Pressurized air may additionally or alternatively be blown toward the consolidated filament structure 46, and/or the consolidated filament structure 46 may be squeezed to remove liquid 50. The consolidated filament structure 46 may then be cut to a desired size and shape.

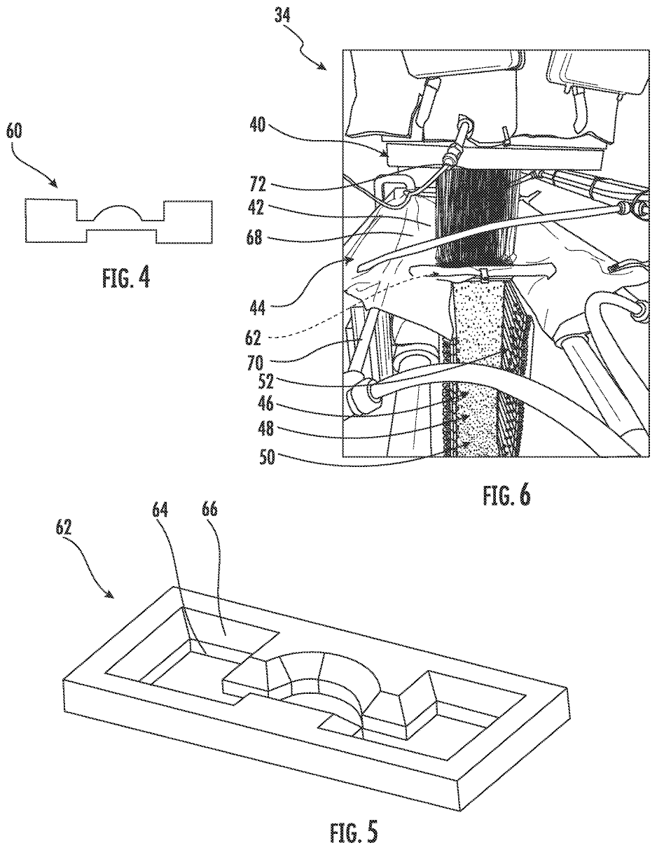

FIG. 4 illustrates a cushioning pad 60 formed by the system 34 of FIG. 3. The cushioning pad 60 is extruded from the system 34 and then, cut from the filament structure 46. The cushioning pad 60 includes a body that is formed from a plurality of the strands 28 to form the unitary body. The cushioning pad 60 has a cross-section illustrated in FIG. 4. The cross-section is nonrectangular so that the cushioning pad 60 is extruded with the shape of the desired cushioning pad 60, to avoid or minimize secondary shaping processes and material scrap. The cushioning pad 60 may be a seat cushion, or may be a portion of a seat cushion, that is assembled with other seat cushion portions. The cushioning pad 60 may be utilized in any padding application, such as seat cushions, backrests, head restraints, armrests, leg rests, and the like.

FIG. 5 illustrates a tool 62 that is provided in the funnel 44 of the system 34 of FIG. 3. With continued reference to FIG. 5, the tool 62 is provided as a plate 62, referred to as a funnel plate 62. An aperture 64 is formed through the plate 62 to guide and funnel the strands or molten filaments 42, of thermoplastic resin into the cooling chamber 48. The through aperture 64 is sized to match the overall profile or perimeter of the cushioning pad 60 when viewed in the direction of the view of FIG. 4. Therefore, the molten resin strands 42 are collected, guided, and cooled into the cushioning pad 60. The plate 62 shapes the mesh of molten resin strands 42 into the overall profile of the cushion 22 as the strands 42 buckle, loop, and intersect. The plate 62 shapes the mesh before the mesh solidifies into the non-woven mesh assembly of the cushioning pad 60.

The tooling plate 62 includes a leading edge 66 around the through aperture 64 at a filament input end of the plate 62. The leading edge 66 may be a chamfer, as illustrated, a fillet or the like. The leading edge 66 guides the filament strands 42 into the plate aperture 64.

FIG. 6 illustrates the tooling plate 62 installed in the funnel 44 of the system 34. The tooling plate 62 is covered by a fabric material 68 which covers the tooling plate 62 for receipt and contact of the filaments 42. The fabric material 68 is lubricated to facilitate cooling and resistance to the filaments 42 as the filaments 42 travel along the leading edge 66 of the plate 62. The fabric material 68 is utilized to maintain the lubricant upon the leading edge 66 during the dispensing operation. The lubricant can be water 50 or otherwise consistent with the liquid 50 in the tank 48. The system 34 includes fluid lines 70 to convey the lubricant from the tank 48 to the fabric material 68.

FIG. 6 illustrates an uninterrupted flow of the molten thermoplastic resin of filaments 42 from the extrusion die 40. Unless otherwise stated, the term “molten” as used herein means that the material is at least partially melted. It does not mean that the material is necessarily in a fully liquid state; rather, it means that the material is not completely solid and is still able to flow through elements of the system 34. For example, the molten material is still able to flow through the die plate 40, but it may be very viscous and starting to solidify. Once the solid granules of the polymeric material are melted in the extruder 38, the material begins to cool as it ceases to be agitated by the extruder screw and gets farther from any heaters. At different points in the process 34, the material may have a higher or lower viscosity, but if it is still partially melted and able to flow-even slowly-the term “molten” is applied herein.

In FIG. 6, the molten strands 28 and films 30 are illustrated entering into the funnel plate 62 for passing through to the cooling chamber 48. In the cooling chamber 48, flow of the filaments 42 is resisted by the fluid to buckle, bend, and bond with each other. A subset of the strands the filaments 42 are further resisted and buckled along the leading edge 66 to provide a denser concentration of the strands 28 around the perimeter in comparison to the concentration of filaments offset within the perimeter. The denser concentration of strands 28 around the perimeter form the film or skin 30. The filaments 42 cool and solidify within the cooling chamber 48 as the strands 28 and the films 30 that form a unitary body as the cushioning pad 60.

The extrusion die 40 includes a plurality of nozzles 72 that exceed an overall area of the through aperture 64 of the plate 62 so that the filaments 42 engage the fabric 68 along the leading edge 66. The nozzles 72 are arranged in an array and a quantity of rows of filaments 42 may be selected to engage the leading edge 66. For example, one row of filaments 42 engaging the leading edge 66 and gathering on the edge 66, results in the skin 30 denser than the remaining strands 28. If two rows of filaments 42 engage the leading edge 66, a denser (or medium thickness) skin 30 is generated. Likewise, when three rows of filaments 42 are aligned around the perimeter to engage and converge at the leading edge 66, a thick skin 30 is generated. Additionally, if all of the nozzles 72 are aligned with the through aperture 64, little to no skin 30 is provided around the perimeter.

The exterior skin 30 provides a surface tension for a continuous seating surface across the cushion 22 similar to a skin along a foam cushion for support and comfort to the occupant. The skins 30 also provide surfaces for attaching other seating components by an adhesive, a hook and loop fastener, or the like. As illustrated in FIG. 2, another layer 74 is attached to the exterior film 30. According to one embodiment, the layer 74 is the trim cover 26. According to another embodiment, the layer 74 is an actuator 74, such as an air bladder assembly 74. According to even another embodiment, the layer 74 is a heat transfer layer 74, such as a heating mat 74. The layer 74 may also be a trim component 74 or tab for attaching to other trim components such as a carrier 76 (FIG. 1). The layer 74 may also be a support 74 for attachment to a seat frame 78 (FIG. 1).

Seat cushions are often molded from a foam material. Foam cushions require dedicated tooling to mold each cushion component. In contrast to prior art mold tooling, the seat cushioning pad 60 of FIG. 4 utilizes the dedicated tooling plate 62 of FIG. 7. The system 34 of FIGS. 3 and 6 includes flexible equipment suitable for fabricating various cushions with various tooling plates. When utilized with the tool plate 62, the nozzles 72 that are outside of the perimeter of the leading edge 66 are closed so that the extruded filaments 42 are dispensed into the aperture 64 and leading edge 66. The closed or open operation of each nozzle 72 can be adjusted for each tooling plate 62. Likewise, the rows of nozzles 72 outside the aperture 64 can be adjusted for determining the strand concentration at the skin 30.

The tooling plate 62 induces a shape upon the cushion 22 before the strands 28 cool, cure, and solidify into the non-woven mesh cushion material. Secondary forming processes to create shape, contour, seating surfaces, and connection surfaces can be eliminated. The cushioning pad 60 is cut from the otherwise continuous formed mesh assembly 46. Alternatively, the cushion 22 may be formed from a plurality of mesh assembly segments 60 with a sequentially transitioning overall profile, which are combined within the trim cover 26. The segments 60 may be glued, welded, or otherwise fastened together.

The tooling plate 62 may have varying angles along various surfaces of the leading edge 66 to obtain the desired material resistance. The tooling plate 62 may be formed from a rapid manufacturing process, such as by machining, three-dimensional printing, or the like. The tooling plate 62 may be machined from a metal alloy or from a polymeric material. Likewise, the tooling plate 62 may be printed from a polymeric material.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A product comprising a body formed from a plurality of strands of expanded thermoplastic resin with a nonrectangular cross section, wherein a concentration of the plurality of strands about a perimeter of the nonrectangular cross section is greater than within the perimeter to provide a contact surface about the perimeter.

2. The product of claim 1, wherein the plurality of strands about the perimeter of the nonrectangular cross section with the concentration greater than within the perimeter is further defined as a plurality of rows of strands.

3. The product of claim 1, wherein the body is sized to provide a cushioning pad.

4. A seat assembly comprising:
a seat frame; and
the cushioning pad of claim 3.

5. A method of manufacturing a product, comprising:
dispensing, through a tool with an aperture sized to match an overall cross section of a product, an outer plurality of strands of a molten thermoplastic resin to engage a leading edge and then pass through the aperture, and an inner plurality of strands of the molten thermoplastic resin to pass through the aperture without engaging the leading edge; and
resisting a flow of the plurality of strands while cooling the plurality strands, the resisting providing a unitary non-woven body in a shape of an overall perimeter of the product with an increased concentration of the strands along a perimeter of the cross section of the product in comparison to a concentration of the strands contained within the perimeter.

6. The method of claim 5, wherein the tool has a nonrectangular cross section matching an overall nonrectangular cross section of the product.

7. The method of claim 5, wherein the product is further defined as a cushioning pad.

8. The method of claim 5, further comprising:
dispensing the molten thermoplastic resin with an array of nozzles that exceeds an area of the of the aperture so that the molten thermoplastic resin engages the leading edge.

9. The method of claim 8, further comprising:
dispensing the molten thermoplastic resin with an array of nozzles that exceeds the area of the aperture up to three rows of nozzles within the array.

10. The method of claim 5, further comprising:
lubricating the leading edge prior to, and/or during, the dispensing of the molten thermoplastic resin.

11. The method of claim 10, further comprising:
lubricating the leading edge with water.

12. The method of claim 5, further comprising:
lubricating a fabric displaced along the leading edge prior to, and/or during, the dispensing of the molten thermoplastic resin.

13. A product formed from the method of claim 5.

14. The product of claim 13, further comprising a seat cushioning pad.

15. The method of claim 5, further comprising:
installing the body as a cushioning pad to a seat assembly.

16. A seat assembly manufactured according to the method of claim 15.

17. The method of claim 5, further comprising machining the tool body.

18. The method of claim 5, further comprising forming the tool from a metallic alloy.

19. The method of claim 5, further comprising three-dimensional printing the tool.

20. (canceled)

21. A tool comprising a tool body with a through aperture and a leading edge about the aperture, the through aperture sized to match an overall perimeter of a product, the leading edge and the through aperture sized to receive a molten thermoplastic resin as a plurality of dispensed strands, wherein the tool through aperture is sized to maintain the plurality of dispensed strands within the overall perimeter of the product.

22-26. (canceled)
